(19) United States
(12) Patent Application Publication
(10) Pub. No.: US 2021/0065540 A1
(43) Pub. Date: Mar. 4, 2021

(54) Intelligent Construction Beacon

(71) Applicant: Dane L. Galden, Columbus, OH (US)

(72) Inventor: Dane L. Galden, Columbus, OH (US)

(21) Appl. No.: 16/556,610

(22) Filed: Aug. 30, 2019

(51) Int. Cl. G08G 1/01; H04W 28/10; H04W 4/40; G08G 1/0968; G01C 21/36; G01C 21/34

(52) U.S. Cl. CPC G08G 1/0145; H04W 28/10; H04W 4/40; G08G 1/096894; G01C 21/3492; G08G 1/096855; G08G 1/0116; G08G 1/0129; G01C 21/3415; G01C 21/3655

(57) ABSTRACT

An intelligent beacon system captures local, authorized changes to vehicle traffic flow plans for response to anomalous road conditions, obstacles, construction, events, and the like, and wirelessly communicates a new traffic flow plan in a variety of forms to vehicles in the vicinity. The variety of forms include human-readable indicia, such as pictorial maps, text, and audible messages, as well as machine-readable indicia, such as digital maps and other representations of the new traffic flow plan. The system includes a configuration device for the entry of traffic flow plans and one or more intelligent beacons for communicating with vehicles. The system may further include one or more base stations in communication with the configuration device and intelligent beacons. System components may be stationary, mobile, self-propelled, or airborne. Beacons may further incorporate conventional traffic warning and direction signaling components, as well as traffic, weather, and other sensors.

### BACKGROUND

This disclosure pertains to systems for indicating temporary traffic conditions, e.g., pertaining to road hazards, emergency situations, and construction projects.

### SUMMARY

An intelligent beacon system provides vehicles with information for how to traverse roadway obstacles. A user enters a traffic flow plan into a field configuration device. The local traffic configuration may include, for example, rules for temporary traversal of local traffic rules and markings, as may be required for emergencies or construction. The information may include a range in time during which the changes apply, e.g., to convey whether changes apply only at certain times or until further notice.

Information regarding the local traffic configuration is provided wirelessly to vehicles in the local vicinity of an obstacle. Communicating to different vehicles and drivers may entail communicating the information in a variety of formats, such as human-readable text and pictorial maps, as well as audio messages, and machine-readable indicia which may be used by navigation systems and autonomous vehicles.

Optionally, intelligent beacons may incorporate traditional beacon features, such as lights, signage, reflectors, sirens, and the like. Further, intelligent beacons may be adapted to be stationary, hand held, mounted on road vehicles or equipment, or carried by airborne devices such as drones.

An intelligent beacon may be further capable of reporting a traffic configuration and other data to a remote site and may be capable of being configured remotely. Differential access to the system may provide, for example, certain operators the option of selecting among a selection of pre-configured modes for a given obstacle site.

In addition to communicating when roads are closed and detours are therefore required, intelligent systems may be used to capture and communicate other aspects of obstacles or other unusual situations. The system may do so wirelessly, well before drivers are able to see posted signage related to an obstacle. Thus, a driver or driverless vehicle may be prepared to address an obstacle before encountering emergency vehicles, flaggers, rows of parked cars, convoys, and slow-moving vehicles, for example.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings. The drawings are not to scale.

FIG. 1 is a block diagram of an example scenario in which intelligent traffic beacons may be deployed.

FIG. 2 is a flow diagram of an example intelligent traffic beacon process.

FIG. 3 is a map of a hypothetical road network.

FIG. 4 illustrates an example of an obstacle and alternate route on the road network of FIG. 3.

FIG. 5 illustrates an example traffic flow plan in the vicinity of an obstacle.

FIG. 6 is an example pictorial map created for a human driver approaching the vicinity of the obstacle of FIG. 5.

FIG. 7 is a system diagram of an example node of an intelligent beacon system, in which a field configuration device or intelligent beacon may be embodied.

FIG. 8 is a block diagram of an example computing system in which a node of an intelligent beacon system may be embodied.

### DETAILED DESCRIPTION

### A. System Overview

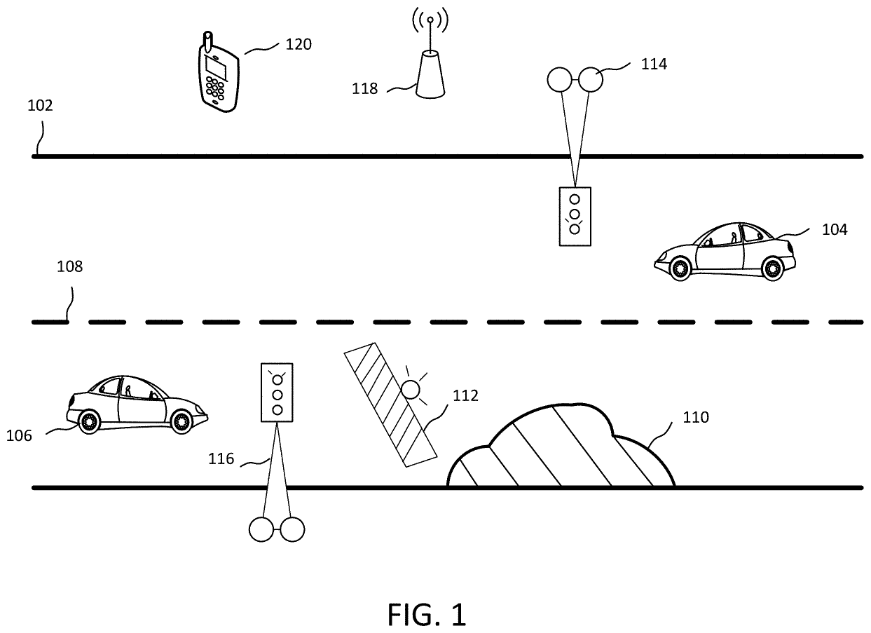

FIG. 1 is a block diagram of an example scenario in which intelligent traffic beacons are deployed to communicate changes in a traffic flow plan to address a roadway obstacle. Herein, the term “obstacle” is used to refer generally to the vicinity of any situation which may require the creation and communication of a new traffic flow plan. An obstacle may be caused by a physical road hazard, such as an accident, roadway debris, roadway damage, parked or slow-moving vehicles, unusual pedestrian traffic or wildlife, construction lane closures, and the like. More generally, herein the term “obstacle” may also refer to the vicinity of situations requiring special efforts to achieve an orderly flow of traffic. For example, herein the term “obstacle” may refer to a situation where there is a need for an orderly traffic flow plan in an area in which no ordered traffic flow plan is normally present, e.g., in parking fields for special events, or on private or governmental property where traffic is not normally allowed. Such obstacles may be caused, for example, by weather events, police, military, rescue activities, or other situations. Intelligent beacon systems may be deployed to help drivers and driverless vehicles safely navigate through or around such obstacles.

In the example of FIG. 1, a two-way roadway 102 is divided by a lane marking 108. There are two cars 104 and 106 on the roadway 102, traveling in different lanes and in opposite directions. In the path of car 106 is beacon 116, followed by a barrier 112 and a road hazard 110. In the path of car 104 is beacon 114.

In the example of FIG. 1, a field configuration device 120 is in communication with a field base station 118. The field base station 118 is in communication with two intelligent beacons 114 and 116.

In practice, the functions of the configuration device, base station, and a beacon may be packaged in any combination. However, it may be advantageous, for example, for a site manager to use a configurator that wirelessly connects to a base station to avoid having to be physically at the base station to enter changes to the traffic plan. Similarly, it may be advantageous to make the beacons and the base station be separate devices, so that beacons may be added as required.

The field configuration device 120 may be a mobile device, such as a cell phone, laptop computer, or tablet computer that is in wireless communication with the base station 118. Additionally or alternatively, the field configuration device 120 may be in direct communication with either, or both, of the beacons 114 and 116. Similarly, the field configuration device 120 may have a wired connection to any of the base station 118, beacon 114, or beacon 116. The field configuration device 120 may further be integrated into the base station 118, beacon 114, or beacon 116.

The field configuration device 120 may be used to adjust traffic indications from the beacons 114 and 116, e.g., to direct traffic in the immediate area and provide information to vehicles and drivers via visual, audible, infrared, or radio means. Wirelessly communicated information may contain information in a variety of formats, such as human readable maps, text, and audio recordings, and additionally or alternatively include machine-readable formats, such as GPS coordinate descriptors of lane locations and traffic flow plan rules.

Ideally, an intelligent beacon system such as the one illustrated in the example of FIG. 1 will provide vehicles with complete official information for how to traverse a roadway obstacle. To do so, the system will capture decisions about the local situation, especially where on-the-scene human judgement is required to respond to contingencies. The information may bear the imprimatur of official government notice, which is important since it may require acting in violation of normal traffic rules and conventions. The information may include a range in time during which the changes apply. The information is provided wirelessly to vehicles in the local vicinity of the obstacle. Communicating to different vehicles and drivers may entail communicating the information in a variety of formats.

Optionally, intelligent beacons may incorporate traditional beacon features, such as lights, signage, reflectors, sirens, and the like. Further, intelligent beacons may be adapted to be stationary, hand held, mounted on road vehicles or equipment, or carried by airborne devices such as drones.

### B. Example Map

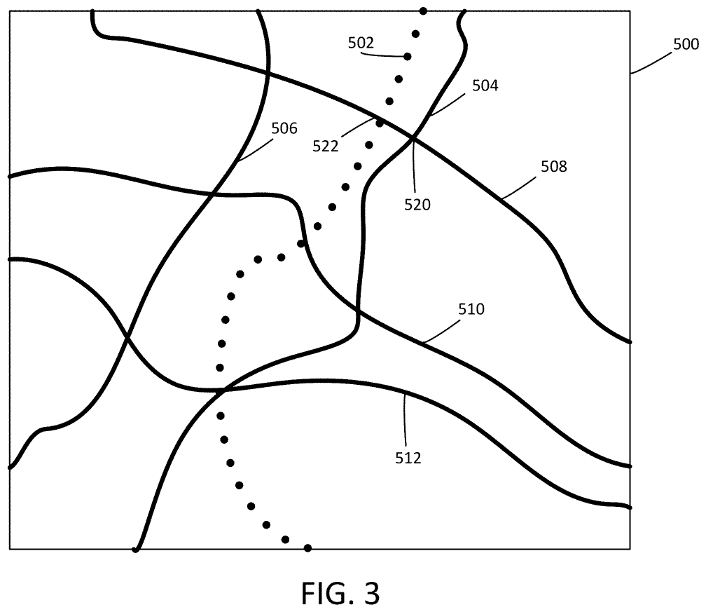

FIG. 3 is an example road map 500. Down the center vertically is a river 502. On either side of the river are two roads 504 and 506 heading generally north/south. Three roads 508, 510, and 512 run generally east/west, crossing the river 502. There is a bridge 522 where road 508 crosses the river 502. There is an intersection 520 where road 504 crosses road 508.

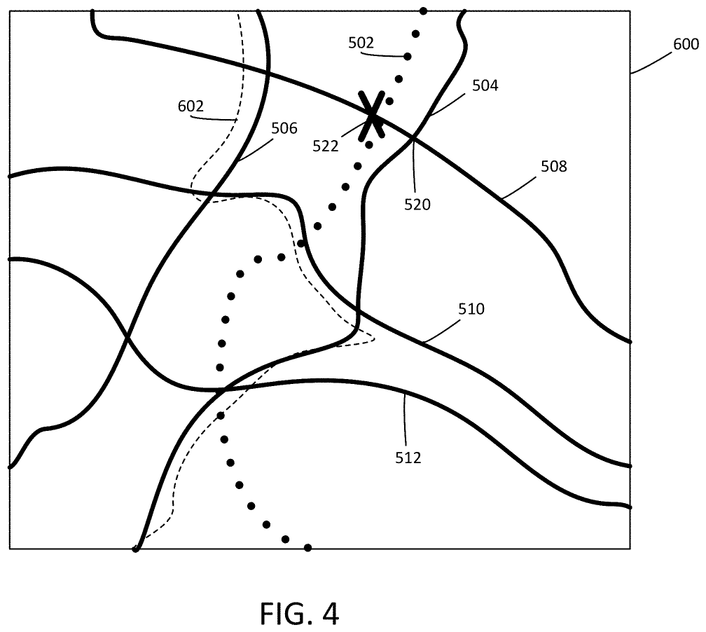

FIG. 4 illustrates an example modified map 600 including an obstacle and an alternative route 602 added to map 500 of FIG. 3. In the example of FIG. 4, the obstacle is a failure of the span of bridge 522, causing a complete closure of road 508 at the river. Route 602 is an alternative path for a vehicle that had planned to proceed on road 504. Now the vehicle will cross to road 506 via road 510.

In the example of FIG. 4, route 602 is depicted as being drawn loosely, as in a free-hand manner. This illustrates how an interface of a field configuration device may appear to a site manager inputting a traffic flow plan. Here, the complete obstacle information so far, in addition to the basic underlying map, includes the blockage at bridge 522 and the recommended alternate route for northbound travelers on road 504.

### C. Example Traffic Flow Plan

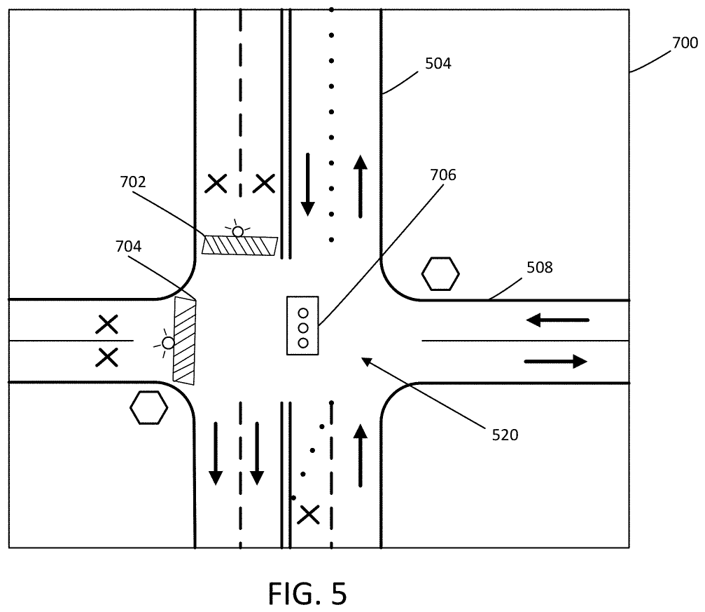

FIG. 5 illustrates a temporary traffic flow plan 700 for intersection 520 of roads 508 and 504. Road 504 is a four-lane divided highway, with the western lanes closed due to construction equipment in preparation for bridge span replacement work.

The eastern lanes of road 504 are now divided by cones. North of the intersection 520, road 504 now carries both northbound and southbound traffic in the eastern lanes. At the intersection 520, southbound traffic returns to the western lanes.

Construction barriers 702 and 704, respectively, block the western lanes of road 504 and all traffic on road 508 west of the intersection 520. Road 508 is a two-lane road. A temporary traffic light 706 now controls traffic in all directions. Previously, the only traffic indications at the intersection 520 were stop signs on road 508.

One or more intelligent beacons may be fitted to the traffic light, traffic barriers, or stop signs. Such intelligent beacons may work in conjunction with other beacons further along either of the roads 504 or 508, or anywhere on map 500 of FIG. 3. By transmitting the traffic flow plan 700 to vehicles prior to reaching the intersection, or at the intersection, the intelligent beacons enable the vehicles and their drivers to be prepared for and heed the new traffic flow plan.

### D. Example Process

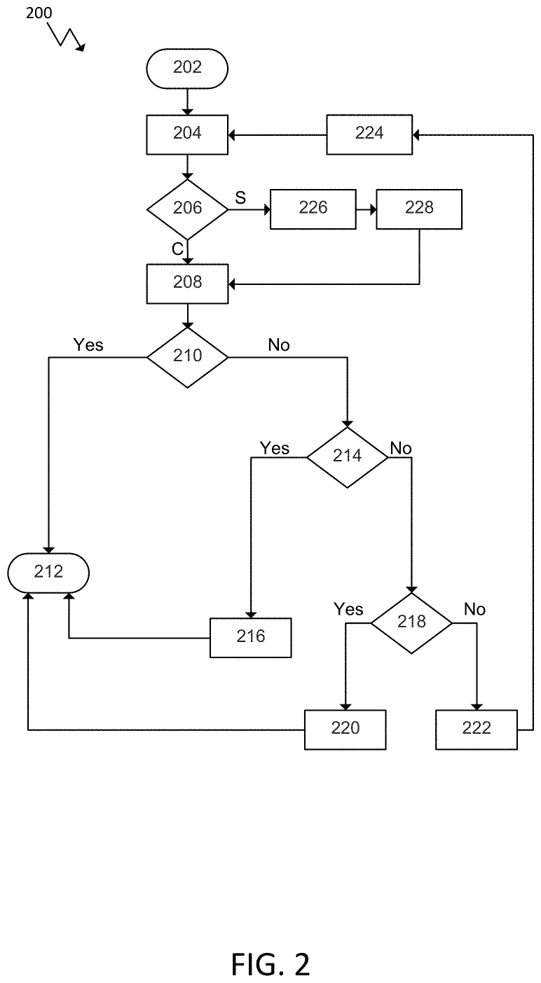

FIG. 2 is a flow diagram of an example process 200 following an intelligent traffic beacon system. Such a process may be implemented by a system of the kind depicted in FIG. 1, which includes a configuration device, a base station, and one or more intelligent beacons. The functionality of the system may be distributed in a number of ways. For example, the configuration functionality may be incorporated in a base station or in one or more beacons.

The process 200 begins at step 202 with an assessment of the available system capabilities. For example, a base station may poll intelligent beacons in the area to determine the number, placement, and status of available equipment for communicating a new traffic flow plan. The base station may then communicate this information to a configuration device so that a user may know what resources are available, and tailor the design of the traffic flow accordingly.

In step 204, the system assesses whether a traffic pattern anomaly is present. An obstacle may be indicated by a user of a configuration device. An anomaly may also be detected via sensors in one or more intelligent beacons, by other roadside equipment, or by systems in communications with roadside sensors. For example, an anomaly may be sensed via an analysis of images of the roadway. Further, an obstacle may be detected according to a schedule that is stored in a base station or signaled by a central traffic control system which is remote from the beacons. For example, scheduled road cleaning or maintenance may be, for purposes of alerting drivers, an obstacle to be navigated, even though its occurrence is not itself anomalous.

In step 206, the system considers whether in the present anomaly lanes are being shifted (S) or closed (C). If the lanes are being shifted, the process proceeds to step 226. If lanes are to be closed, the process proceeds to step 208.

If lanes are being closed, in step 208 the system creates a modified lane diagram. For example, a manager of a roadway construction site (or an emergency responder or construction work scheduler) may use a configuration device to indicate the alteration of the traffic pattern. The basic, normal traffic pattern to be altered may be obtained, for example, from a geographical information database, analysis of roadway imagery, an engineering plan, or input by the user of a configuration device.

In step 210, the system determines whether the pavement is marked, e.g., via painted indications, signs, lights, barriers, or the like.

If the pavement is marked, then in step 212, the system transmits revised lane information to vehicles in the area. For example, a base station may convey the revised lane information to one or more beacons which then wirelessly broadcast the information in the area near the anomaly. Such broadcasts may then be received by vehicles in the area. For example, such information may be received by navigation systems used by vehicles. The information may then be announced and displayed to drivers, used to modify routes selected and displayed by the navigation system, or considered by automatic driving systems and automatic safety features. In other words, precise local information about the anomaly may be obtained and used by drivers and automated driving systems via direct communications with the intelligent beacon system, even before visual contact with beacons or pavement markings is available.

Additionally, in step 212, the system may inform a remote system, such as a central traffic monitoring or control system or news outlet, of the local anomaly and measures being taken accordingly.

If the pavement is not marked, in step 214 the system may refer to a map drawn on, for example, a tablet interface of a configuration device (or other information provided by a user, or an analysis an image of the area), to determine whether regular lanes of traffic are to be used in a new way to accommodate the anomaly.

If regular lanes of traffic are to be used in a new way, in step 216 the system may create a pictorial map to be displayed to drivers to illustrate, e.g., lane sharing or lane shifting in the area. For example, such a map may be of use to drivers who are not using navigation systems yet are able to receive images of the anomaly site on a mobile device, such as a cell phone or other computing device, in order to better understand the traffic situation and safe routing for their vehicle. Similarly, a pictorial map may be used to augment the information available to vehicle navigation systems.

Similarly, in step 216, the system may create a “data map” of the situation in terms that are understood by a navigation system. For example, a data map may use a combination of latitude and longitude, landmarks, or linear measures to express the new traffic pattern. Such a data map may then be used directly by a navigation system, such as a GPS or cellular navigation system, a driverless system, or a car safety override system, to formulate displays or announcements for drivers, alternative routing, or evasive maneuvers.

If routing in the traffic pattern includes segments which are not regular lanes of traffic, in step 218 the system determines whether the new traffic pattern is to include, e.g., partial lanes, lane narrowing, use of the roadway shoulder, or temporary road surfaces. Again, this may be determined via automated analysis, or via interaction with a user of a configuration device.

In step 220, the system creates detailed visual and digital maps and other information to communicate to vehicles the lane shift, partial lanes, lane narrowing, use of the shoulder, or temporary road surfaces, for example. The pictorial map will be shared with human drivers. The digital map may be used by an autonomous vehicle or used by a navigation system to generate instructions to a human driver.

The system may verify the plan for communicating the traffic flow plan. For example, if in step 218 lanes are not marked, not real, or not modifications of existing lanes, then in step 222 the system may require the user of the configuration device to provide more information.

Similarly, to avoid improper modification of a traffic flow plan, in step 224 the system requires proof that the changes are being made by authorized personnel.

If in step 206 a lane shift is indicated, then in step 226 the system may provide a user with one or more templates for the traffic flow. For example, rather than having the user manually enter each scenario, for a four-lane highway with available shoulders, to close a right lane, the system may offer the options of diverting all traffic to the left lane and of diverting the right lane of traffic to the shoulder.

The shift may also detect and verify breaches of normal traffic rules and conventions implied by a proposed traffic flow plan. For example, in step 228, the system may determine if a proposed traffic flow plan includes a complete lane shift, the use of partial lanes, or crossing a roadway center line. If so, the system may again ask for clarification or authentication by the user.

It will be appreciated by those skilled in the art that the ideas expressed herein may be combined in a wide variety of sequences and configurations without departing from the essence of what is taught.

### E. Example Driver Aid Pictorial Map

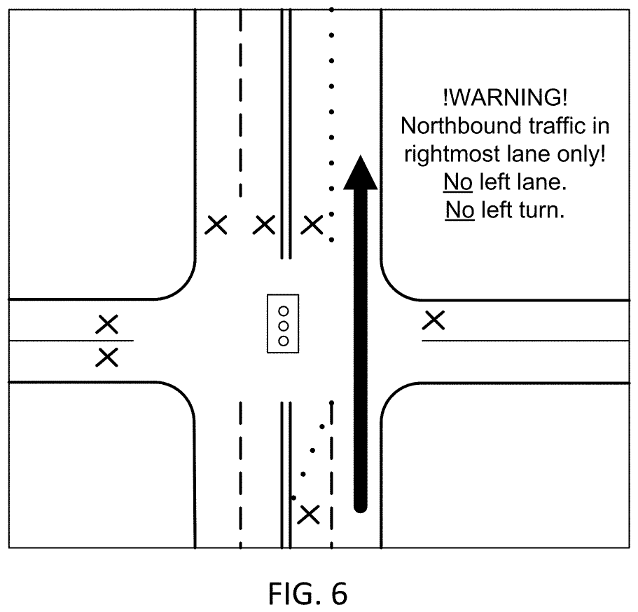

FIG. 6 illustrates an example pictorial map that may be provided to a human driver's mobile device or a vehicle's navigation system. The map of FIG. 6 corresponds to the traffic flow plan of FIG. 5 as applied to a northbound driver. The features are similar to that of FIG. 5. However, here in FIG. 6 the data display is simplified for purposes of rapid assimilation by a human driver. The driver needs to know that, unlike the past, the left northbound lane is closed before the intersection and remains closed above the intersection. Further, there is a light and traffic may come to a complete stop.

The graphic image in the example of FIG. 6 includes a text warning to the driver. In practice, the text may be sent separately, e.g., as a text or audio message to the driver, either via a cell phone app, for instance, or via a vehicle navigation system. The image may similarly be displayed by an application on a driver's mobile device, or as an inset in a GPS system display, for example.

### F. Complete Information for Traversing Obstacles

A system incorporating one or more intelligent traffic beacons may capture a complete, real-time view of an entire construction zone or other traffic anomaly area, and then relay to vehicles how the area is currently configured, and thereby how it should best be navigated.

An intelligent beacon system may communicate any kind of information. Preferably, however, it will provide complete official local information that addresses the situation of the obstacle in the broader context of governmental response to current conditions. Any alterations to the information should ideally only be made by those permitted to do so by the controlling authority, such as a construction site manager, emergency responder, or transportation person with specific authorization to alter the system, or via a sophisticated pre-approved autonomous system that interprets numerous data points from the overall complete picture of the situation at hand.

In contrast, solely crowd-sourced traffic information, for example, may not include the best information about unusual traffic situations, or do so on a timely basis. A crowd-source system typically relies on the analysis of car movements or amateur reports provided after a situation has occurred, been detected, and been reported by drivers. Crowd-sourced data itself does not include official intentions, e.g., as to future lane closures or openings and detours being established to enable vehicles to avoid or traverse the obstacle. Similarly, systems relying on central dispatch of traffic flow plan information may suffer from delays and inaccuracies in understanding the local situation.

It is therefore preferable that an intelligent beacon system acquire and report complete information locally. Such information may include an official intended response to the obstacle. It may include, for example, when the use of the roadway shoulder is permitted by officials, versus when the shoulder must be kept clear. Such details may change quickly, for example, at an accident scene.

Complete information may include complete digitized descriptions of the temporary lane locations, which otherwise may be unclear from visual cues, e.g., until sufficient signage, pylons, flaggers, or flares are put in place. A human flagger is doing a dangerous job. By providing virtual flagging from an intelligent beacon, the threats to emergency responders and construction workers may be reduced.

Complete information may include information regarding routing away from the obstacle itself. For example, complete detour route information may be provided, as well as schedules for events and construction, repair schedule estimates, suggested best travel times, etc.

A driver passing an obstacle, such as a washed-out bridge, for instance, is more likely to have a need to know the details of when the roadway may be restored, than is a driver who is hundreds of miles away. Flooding all vehicles with all the information leaves a complex task undone of determining which vehicles need which piece of information. Further, a manager of the bridge restoration project, for example, will have better information about traffic patterns in the vicinity of an obstacle, e.g., when lane closures may occur on nearby roads to facilitate bringing in construction equipment or replacement bridge span elements. Lastly, automated data transfer from an intelligent beacon to a vehicle system provides faster, safer, and more complete data transfer than does a driver trying to read details on a temporary sign while driving past. Thus, an intelligent beacon that includes a field configurator, for example, provides a way to capture better, more detailed information, and then better disseminate that information safely and conveniently.

### G. Autonomous Vehicle Control

Autonomous vehicles are, by definition, those that make their own driving decisions in the field based on their observations of the environment. This is extremely challenging, especially in dealing with obstacles. It would be difficult, and perhaps impossible, to program an autonomous vehicle to handle every imaginable scenario in which roadway traffic patterns may be configured and re-configured on a temporary basis. Traffic patterns may be improvised by emergency responders or construction crew chiefs, for example, to accommodate the unforeseen circumstances of road construction, emergency responses, and hazardous conditions. Unplanned failures of construction equipment, accidents occurring in construction zones, and emergency evacuation situations, for example, require improvisation in the field to keep traffic moving.

Furthermore, construction signage, cones, barrels, and other markers may be insufficient or confusing even to experienced human drivers, particularly when the markings are not clear, are used inconsistently from one site to another, or have positions altered by contact with other vehicles. Traffic patterns around obstacles may change based on the time of day. Further, gaps in traffic indications such as pylons, which are meant to allow access to roadway exits or driveways, may easily be mistaken for the end of a construction zone, for instance. In short, obstacles often present anomalies which may inadvertently be interpreted to indicate traffic flow plan changes which were not intended by the personnel managing a construction zone or other traffic change.

Autonomous vehicles, even more than human drivers, may have difficulty interpreting temporary traffic flow plan information. Conversely, autonomous vehicles may have an easier time following complex traffic flow plan information, provided that such information is provided in a machine-readable format. In other words, an autonomous vehicle will find it much easier to follow complex detour instructions than will a human driver, but the autonomous vehicle will find it harder to understand human indicia, such as unusual signs, unusual lane arrangements, flaggers, or random unmarked individuals attempting to act as flaggers by waving their hands.

This has two significant consequences for intelligent beacon systems. The first is that autonomous vehicles have a heightened need for complete local information, in contrast to the needs of human drivers, although both are well served by intelligent beacons. The second is that the complete information provided by an intelligent beacon may include differentiated instructions for human-driven vehicles versus autonomous vehicles. For example, autonomous vehicles may be dispatched to alternate routes which require more precise braking, or routes that have poorer visibility, than detour routes that are suggested for human drivers. Similarly, different traffic flow plans or routes may be prescribed for different classes of vehicles, e.g., cars, trucks, emergency vehicles, military convoys, etc.

### H. Collection of Locally Generated Traffic Flow Plans

Traffic flow plan information, i.e., plans for traffic flow to address obstacles, may be complex and unexpected. They may require, for example, violations of normal traffic protocols, such as crossing a roadway center line, ignoring a traffic light, or driving on the wrong side of the road. Such traffic flow plan information is often best captured and communicated locally. Human judgment by those on the scene and in charge is often required. An intelligent beacon system, therefore, may preferably include a local configuration device with an interface that the allows easy, accurate, and detailed information.

A configuration device may capture the intentions of a designer of a detour or other temporary or anomalous traffic pattern in a number of ways. A precise drawing of an entire construction area, for example, may be used as a first input. Such a drawing may then be annotated with comprehensive data on changes in traffic patterns, lane closures or restrictions, alterations in the width or dimensions of lanes, demonstrations of how lanes swerve/veer/pinch over, temporary use of shoulders or side roads, special permissions to go across yellow lines under certain conditions, or any other type of traffic pattern change necessitated by construction, emergencies, hazards, obstructions, or any other reason deemed important and necessary by the governing authority with permission and access to the traffic beacon invention.

Similarly, a configuration device may use a captured visual image of a scene as the basis for designing traffic flow plans in and around an obstacle. A user may photograph the existing lanes, then add markings to the photo to indicate changes, which the system then translates into more complete representations to share with vehicles.

Further, a configuration device may be arranged to enable a user to enter a free-hand drawing of an obstacle site using, e.g., a finger, stylus, trackball, finger, or mouse. Such a user-generated image may then be converted into a more regular image by the system, and then annotated by the user.

A configuration device may accept a traffic flow plan in the form of textual or numeric inputs. For example, a user may indicate variations from a normal plan by indicating appropriate distances, mile markers, and other boundaries, as well as keywords or phrases for changes. Similarly, a menu-driven or keyword suggestion interface may be used in combination with, or instead of, a photo image, sketch, or engineering drawing interface.

The configuration device may provide for the official signature of the traffic flow plan, e.g., via authentication or requiring credentials. This enables the configuration device to add an indication of official approval of the traffic flow plan, so that vehicles may be aware of the provenance of the proffered data. In other words, vehicles receiving information from an intelligent beacon will be able to distinguish an official notice versus a rumor or a crowd-sourced suggestion. This may be critical in conveying the need and propriety of breaching normal traffic laws and configurations in special circumstances.

The configuration device may provide templates for traffic flow plans, such as standard plans and procedures for dealing with anticipated roadway patterns and scenarios. These may be selected by a user to apply at the site of an obstacle and may be modified by the user as required.

### I. Traffic Flow Plan Time Information

An intelligent beacon system may collect and distribute information relating to when and how long a traffic flow plan is in effect. For example, a configuration device may capture, and an intelligent beacon may broadcast, schedules of planned upcoming road maintenance work and associated lane closures and diversions. The system may indicate that a traffic flow plan is in effect “until further notice,” for example, in the case of a washed-out bridge, or days and dates when the traffic flow plan will be in effect. For example, it may indicate that in 20 minutes the road will be completely shut for a period of ten minutes, where after it will be reduced to one lane northbound for 0.25 miles until 10 PM, but there will be no lane restrictions southbound after the five-minute closure. Similarly, the system may be used to communicate permanent changes in traffic patterns to vehicles and drivers.

### J. Local Information Reporting

An intelligent beacon may be adapted to inform a human vehicle driver or an autonomous vehicle of unusual or temporary traffic situations in a number of ways. For example, communications may be restricted by medium, frequency, or protocol to be limited to a local area. Infra-red or infrasonic signals may reach vehicles only in a certain area. Short-range radio signaling may be used. Wireless signals may be tagged, for example, with geographic identifier information, such that they may be filtered for relevance by a receiver.

Limiting communications to specific vehicles as they approach the site of an obstacle, rather than flooding all vehicles in the general area with more information than can be readily processed, reduces the chances of important information being missed by a receiving system.

The physical location of a beacon need not be fixed. For example, an intelligent beacon may be mounted on a moving (or moveable) piece of construction equipment, an emergency vehicle, a slow-moving vehicle, or a member of a convoy. For example, an intelligent beacon may be affixed to: a public transit vehicle such as a city bus; a parking shuttle van; a utility metering vehicle; a postal or parcel delivery vehicle; or a taxi or hired car. The operation of the beacon may be tailored to particular operations. For example, a may carry an intelligent beacon that is normally inactive but is activated when approaching the location of an inspection, pickup, pickup, or drop off, etc., where the vehicle anticipates slowing down or stopping, such that the intelligent beacon makes other vehicles in the area aware of the anticipated maneuver.

An intelligent beacon may further be affixed to a drone flying apparatus, for example, for rapid dispatch to an obstacle, or a portion of roadway that approaches the obstacle.

### K. Electronic Information in Multiple Human Formats

An intelligent beacon system may provide information to human drivers in a variety of ways. Wirelessly transmitted data from beacons may include audio messages for drivers, as well as text or maps. Photos or other images may be provided of the obstacle, or provide background on the situation of the obstacle.

### L. Electronic Information in Machine Readable Formats

An intelligent beacon system may provide machine-readable traffic flow plan information in a variety of formats. For example, a configuration device, base station, or intelligent beacon may translate a human readable instruction, an engineering drawing, or an annotated image into formats which are usable by autonomous vehicles' vehicle navigation systems.

M. Integration with Signs, Lights, Sirens, Sensors, etc.

Components of an intelligent beacon system, in addition to providing information to vehicles wirelessly, may incorporate audible and visual signals, such as sirens, lights, and signage, to aid human drivers. Similarly, components of an intelligent beacon system may incorporate features for signaling to autonomous vehicles in addition to wireless communication systems. For example, an intelligent beacon may show a bar code pattern or sonar pulse to convey a warning to or communicate with autonomous vehicles over optical or acoustical spectra, for instance.

Intelligent beacons or base stations, for example, may advantageously be fitted with one or more sensors to detect light levels, observe weather conditions, capture images, or gauge the number, speed, type, size, or weight of vehicles. Such sensor data may be reported back to other components of the local intelligent beacon system and relayed back to remote traffic monitoring and control centers.

### N. Base Stations

An intelligent beacon system may house certain features in a base station. For example, equipment for translating traffic flow plan data from one format to another, communicating with a variety of beacons, or communicating with remote systems may be housed in a base station. A base station may be useful as a hub for a network of base stations and include a higher-power or longer-distance transmitter than individual intelligent beacons have. A base station may be, e.g., advantageously placed to the side out of the way of potential roadway collisions, and further monitor and address the health of individual beacon devices.

### O. Beacon Placement

There are several options for the physical placement of intelligent beacons. For instance, since a wireless intelligent beacon does not necessarily have to be placed in the line of sight of a vehicle, in some cases it may be better to avoid mounting such radio transmission devices on cones, pylons, barrels, signs, or other traffic that may be prone to being hit by vehicles. It may be safer to put fewer such devices in and around an obstacle, since their placement, removal, and driving around all involve some risk to workers and drivers. Further, placing the transmitter in the line of danger introduces an unnecessary mode of failure by vehicle collision. Therefore, it may be advantageous to place intelligent beacons in stationary positions away from the roadway edge.

### P. Mobile Beacons, Configuration Devices, and Base Stations

There is no strict requirement for an intelligent beacon to be stationary. An intelligent beacon may be carried by an emergency vehicle or a convoy, for example, to convey the needed information to nearby vehicles wherever the emergency vehicle or convoy goes, alerting autonomous vehicles or human drivers to move safely to allow the emergency vehicle or convoy to pass safely.

This may avoid certain complexities of convention systems. For example, the use of a moving intelligent beacon means that an emergency vehicle dispatcher does not need to send out continuous updates of emergency activities so that other vehicles may be aware of an emergency vehicle's path. Rather than flooding communication channels with updates, the information flow may be generally restricted to the vicinity of an ambulance, for instance, to keep the updates relevant, local, and certain.

Such a mobile intelligent beacon may be useful for routine vehicle operations, e.g., where frequent stops occur for postal services and delivery vehicles, school buses, and any vehicle making frequent stops or engaging in another unusual driving behavior.

Similarly, a configuration device or a base station may be mobile. Configuration devices may be stationary computers, for example, that are mounted to moveable construction equipment or to vehicles, as well as mobile computing devices such as tablet computers and cell phones. A base station, which receives and conveys configuration information, in one form or another, to intelligent beacons, may similarly be a stationary or mobile apparatus. For example, a base station, or a configuration device which incorporates the functionality of a base station, may be driven through a site to communicate with and configure each intelligent beacon. This may be useful, for example, where distances or geographic features make hardwired communications and even radio telemetry with intelligent beacons difficult.

### Q. Airborne Beacons, Configuration Devices, and Base Stations

An intelligent beacon or base station may be integrated in a self-propelled terrestrial vehicle or flying drone, for example, for swift deployment. For example, where radio communication with intelligent beacons is difficult, a drone may be able to reach a remote beacon more rapidly than is possible with a convention vehicle. After all, the purpose of the intelligent beacons is to address, e.g., road closures, so at times it will not be possible to rely on roadways to provide pathways for beacon programming. Therefore, drones may be the best way to deliver a traffic flow plan and associated visual, textual, and audio messages to beacons.

Other types of information, and such output from the drone, may create the unique programming data that the beacon will use to transmit important anomalies to vehicles that will traverse the re-configured traffic situation, and will also provide electronic and visual information to any authorized user such that official personnel can see the new traffic pattern and confirm its correctness or make any corrections that are deemed necessary. Said drone can fly over on a regular basis to verify the correctness of the information and relay any noted changes that need to be addressed. For the mobile beacons, programming could consist of a continuous signal providing location and other data to nearby cars as a means to inform of speed, direction, and other important data.

### R. Remote Reporting

In addition to reporting traffic flow plan configuration information to vehicles locally, an intelligent beacon system may also report traffic configuration information to remote monitoring systems. For example, a beacon, configuration device, or base station may have a connection to a broader network, such as a wide area network (WAN) cellular network or a satellite network, and thereby access to the Internet. Similarly, it may be connected to a government communication network such as police or military radio. Such a link may be used to report a configuration provided locally using a configuration device. Similarly, the system may report additional information, such as data gathered by sensors or imaging devices, and report such to remote systems. For example, an intelligent beacon may incorporate collision detectors, vehicle velocity sensors, audio recording devices, weather instrumentation, and the like, to gather field intelligence for both local use and reporting to a remote facility. Further, an intelligent beacon system may report its information to other roadway data collection systems.

### S. Remote Configuration

An intelligent beacon system may also be configured through a network connection by a configuration device at a local site. For example, a system may be initially configured in the filed by a user near the obstacle using a field configuration device. Later, the traffic configuration may be altered by a user at a remote location. For example, a remote operator may change the hours during which certain measures are in place, e.g., to accommodate a changing schedule for construction work.

### T. Differentiated Configuration Authority

Configuration privileges may be differentiated for local and remote users fulfilling different roles. For example, full authority for establishing an initial configuration of a traffic pattern may be reserved to an engineer, official, or chief emergency responder, while lesser functions, such as selecting one of a few pre-configured modes, may be delegated to other users. For example, an engineer may provide a road construction set with two traffic configurations—one for when the site is active, and another for when work is dormant. Construction workers may be able to use a field configuration device for the limited purpose of changing the mode of the system from dormant to active configuration when work starts, and back to dormant, for example, at the end of a shift or when weather prevents construction activity during scheduled times. Similarly, a flag man may be permitted limited access to the configuration device to, e.g., enter the number of vehicles waiting in a queue, which may activate a different timing for lights. At the same time, the flag man may not have the ability to change generally how the system operates, for instance. This allows flexibility for local operations without requiring intervention by the authorized engineer, official, or responder in charge.

### U. Example Hardware and Software Architectures

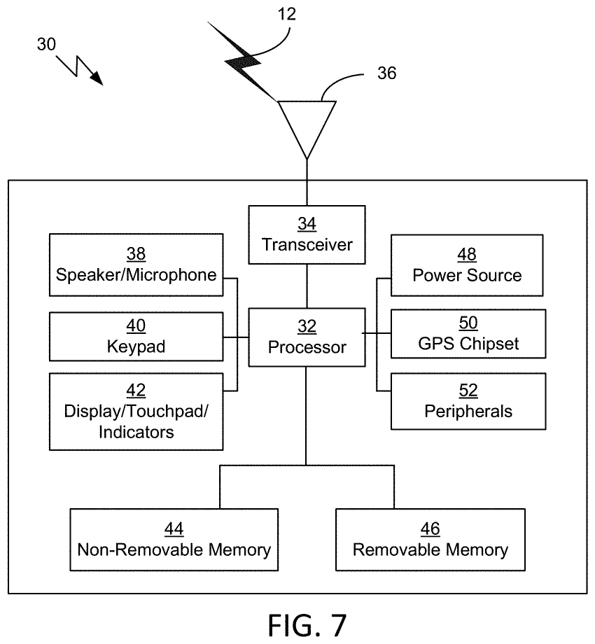

FIG. 7 is a block diagram of an example hardware/software architecture of a node of an intelligent beacon system, such as a field configurator or an intelligent beacon illustrated in FIG. 1 may be embodied. As shown in FIG. 7, the node 30 may include a processor 32, non-removable memory 44, removable memory 46, a speaker/microphone 38, a keypad 40, a display, touchpad, or indicators 42, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment. This node may be a node that implements methods described herein, e.g., in relation to the methods described in reference to FIG. 2 or in a claim.

The processor 32 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), a state machine, and the like. In general, the processor 32 may execute computer-executable instructions stored in the memory (e.g., memory 44 or memory 46) of the node in order to perform the various required functions of the node. For example, the processor 32 may perform signal coding, data processing, power control, input/output processing, or any other functionality that enables the node 30 to operate in a wireless or wired environment. The processor 32 may run application-layer programs (e.g., browsers) or radio access-layer (RAN) programs or other communications programs. For example, the processor 32 may also perform security operations such as authentication, security key agreement, or cryptographic operations, such as at the access-layer or application layer.

As shown in FIG. 7, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the methods described herein, e.g., in relation to FIG. 2 or in a claim. While FIG. 7 depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, devices, and the like. For example, in an embodiment, the transmit/receive element 36 may be an antenna configured to transmit or receive RF signals. The transmit/receive element 36 may support various networks and air interfaces, such as WLAN, WPAN, cellular, and the like. In an embodiment, the transmit/receive element 36 may be an emitter/detector configured to transmit or receive IR, UV, or visible light signals, for example. In yet another embodiment, the transmit/receive element 36 may be configured to transmit and receive both RF and light signals. It will be appreciated that the transmit/receive element 36 may be configured to transmit or receive any combination of wireless or wired signals.

In addition, although the transmit/receive element 36 is depicted in FIG. 7 as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

The processor 32 may access information from, and store data in, any type of suitable memory, such as the non-removable memory 44 or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42.

The processor 32 may receive power from the power source 48 and may be configured to distribute or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software or hardware modules that provide additional features, functionality or wired or wireless connectivity. For example, the peripherals 52 may include various sensors such as an accelerometer, biometrics (e.g., finger print) sensors, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The node 30 may be embodied in other apparatuses or devices, such as a sensor, consumer electronics, a wearable device such as a smart watch or smart clothing, a medical or eHealth device, a robot, industrial equipment, a drone, or a vehicle such as a car, truck, train, or airplane. The node 30 may connect to other components, modules, or systems of such apparatuses or devices via one or more interconnect interfaces, such as an interconnect interface that may comprise one of the peripherals 52.

The displays 42 and peripherals 52 may include lights, such as highway flashers, and roadway signage devices.

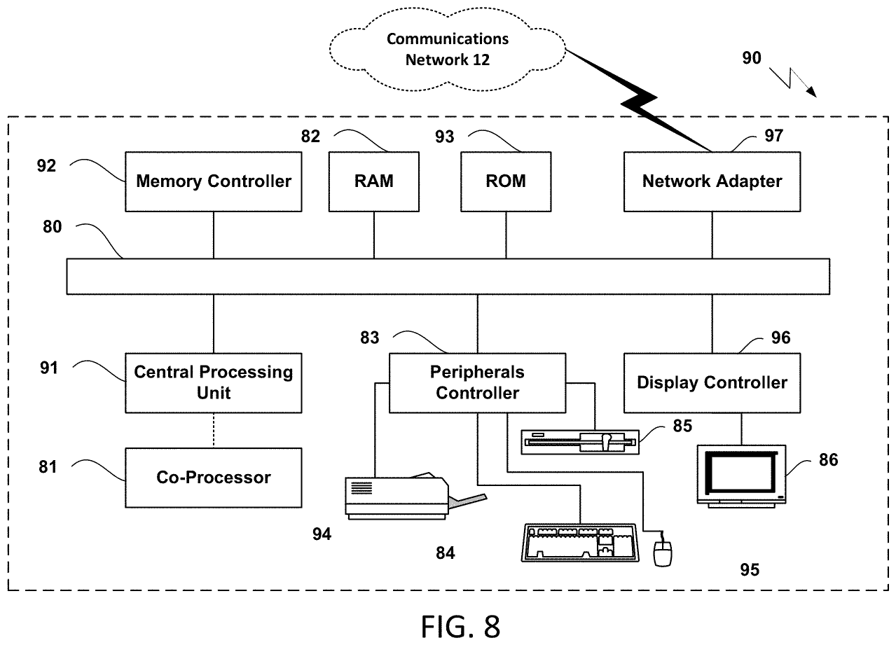

FIG. 8 is a block diagram of an exemplary computing system 90 which may also be used to implement one or more nodes of an intelligent beacon system illustrated in FIG. 1.

Computing system 90 may comprise a computer or server and may be controlled primarily by computer readable instructions, which may be in the form of software, wherever or by whatever means such software is stored or accessed. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Co-processor 81 is an optional processor, distinct from main CPU 91, that performs additional functions or assists CPU 91. CPU 91 or co-processor 81 may receive, generate, and process data related to the disclosed systems and methods for E2E M2M Service Layer sessions, such as receiving session credentials or authenticating based on session credentials.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by CPU 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as, for example, a network adaptor 97, that may be used to connect computing system 90 to an external communications network, such as network 12 of FIGS. 1-4, to enable the computing system 90 to communicate with other nodes of the network.

It is understood that any or all of the systems, methods, and processes described herein may be embodied in the form of computer executable instructions (i.e., program code) stored on a computer-readable storage medium which instructions, when executed by a machine such as a mobile computing device, base station, intelligent beacon, navigation system, server, gateway, or the like, perform or implement the systems, methods and processes described herein. Specifically, any of the steps, operations, or functions described above may be implemented in the form of such computer executable instructions. Computer readable storage media include both volatile and nonvolatile, removable, and non-removable media implemented in any non-transitory (i.e., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computer.

We claim:

1. A system, comprising:
a field configuration device, the field configuration device being a computer apparatus with a user interface arranged to create a traffic flow plan, the traffic flow plan comprising a data representation of one or more lanes of motor vehicle traffic;
a base station, the base station being a computer apparatus, the base station being arranged to process the traffic flow plan; and
an intelligent beacon, the intelligent beacon being a computer apparatus, the intelligent beacon comprising radio communications circuitry and being arranged to wirelessly send the traffic flow plan to one or more nearby vehicles in one or more formats;
wherein:
the field configuration device, the base station, and the beacon are local to each other near a roadway obstacle;
the field configuration device communicates the traffic flow plan to the base station, the base station communicates information regarding the traffic flow plan to the intelligent beacon, and the beacon wirelessly communicates the traffic flow plan in one or more formats to vehicles in a vicinity of the beacon.

2. The system of claim 1, wherein the field configuration device is arranged to accept the traffic flow plan in the form of a textual or numerical description.

3. The system of claim 1, wherein the field configuration device is arranged to accept the traffic flow plan in the form of annotations to one or more of: a map, an engineering drawing, a hand-drawn figure, and an image capture.

4. The system of claim 1, wherein the field configuration device is arranged to accept a different traffic flow plan for the roadway obstacle for each of multiple classes of vehicles.

5. The system of claim 1, wherein the field configuration device is arranged to:
authenticate an identity of a user of the field configuration device; and
include, in the traffic flow plan, an indication of official approval of the traffic flow plan.

6. The system of claim 1, wherein the base station is adapted to convert the traffic flow plan into multiple formats, the multiple formats comprising a human-readable format and a machine-readable format.

7. The system of claim 1, wherein the roadway obstacle is in motion, and wherein the intelligent beacon travels with the obstacle.

8. The system of claim 1, wherein the intelligent beacon is airborne.

9. The system of claim 1, wherein the base station and the field configuration device are co-located.

10. The system of claim 1, wherein the base station and the intelligent beacon are co-located.

11. The system of claim 1, wherein the base station is in communication with a remote traffic control center and adapted to report and date to the remote traffic control center and to receive a modification to the traffic flow plan from the remote traffic control center.

12. An intelligent beacon, comprising a processor, a memory, and communication circuitry, the intelligent beacon further comprising computer-executable instructions stored in the memory which, when executed by the processor, cause the apparatus to:
receive a temporary traffic flow plan from a field configuration device; and
wirelessly send, to vehicles in the vicinity of the intelligent beacon, the temporary traffic flow plan.

13. The intelligent beacon of claim 12, wherein the intelligent beacon is arranged to send the temporary traffic flow plan in a variety of formats, wherein the variety of formats comprises a machine-readable format and a machine-readable format.

14. The intelligent beacon of claim 12, wherein the intelligent beacon is affixed to a motor vehicle.

15. The intelligent beacon of claim 12, wherein the intelligent beacon is airborne.

16. A vehicle navigation system comprising a processor, a memory, and communication circuitry, the vehicle navigation system being connected to an intelligent beacon system via the communication circuitry, the vehicle navigation system further comprising computer-executable instructions stored in the memory which, when executed by the processor, cause the vehicle navigation system to:
receive, from the intelligent beacon system, a first traffic flow plan, the first traffic flow plan replacing an established traffic flow plan for a first location;
determine that the traffic flow plan traverses a traffic rule or vehicle safety guideline;
receive, from the intelligent beacon system, an indication of governmental authority to create an exception to the traffic rule or vehicle safety guideline;
authenticate the indication of governmental authority; and
determine that the exception to the traffic rule or vehicle safety guideline falls within a maximum safe driving envelope of the vehicle.

17. The vehicle navigation system of claim 16, wherein the instructions further cause the vehicle navigation system to inform a driver of the authentication of the exception to the traffic rule or vehicle safety guideline.

18. The vehicle navigation system of claim 16, wherein the instructions further cause the vehicle navigation system to drive the vehicle in accordance with the exception to the traffic rule or vehicle safety guideline.

19. The vehicle navigation system of claim 16, wherein the instructions further cause the vehicle navigation system to:
receive, from the intelligent beacon system, a second traffic flow plan, the second traffic flow plan replacing an established traffic flow plan for a second location;
receive, from the intelligent beacon system, an indication of times during which the second traffic flow plan is valid; and
store, for retrieval at a later time, the second traffic flow plan and the times during which the second traffic flow plan is valid.

20. The vehicle navigation system of claim 16, wherein the instructions further cause the vehicle navigation system to:
receive, from the intelligent beacon system, an indication that the second traffic flow plan is permanent;
create a permanent record of the second traffic flow plan in a non-volatile memory structure; and
note that the established traffic flow plan for the second location is no longer valid.
